(19) United States
(12) Patent Application Publication
(10) Pub. No.: US 2003/0202563 A1
(43) Pub. Date: Oct. 30, 2003

(54) Rate adaptation and antenna selection in a wireless communication system

(76) Inventors: Arnab Das, Old Bridge, NJ (US); Farooq Ullah Khan, Manalapan, NJ (US); Ashwin Sampath, Somerset, NJ (US); Hsuan-Jung Su, Ocean, NJ (US)

Correspondence Address: HARNESS, DICKEY & PIERCE, P.L.C., P.O. BOX 8910, RESTON, VA, 20195, US

(21) Appl. No.: 10/132,453

(22) Filed: Apr. 26, 2002

(51) Int. Cl. H04B 1/69; H04L 27/36

(52) U.S. Cl. 375/146; 375/261; 375/298

(57) ABSTRACT

Downlink physical channels are processed according to one embodiment by scrambling a first downlink physical channel allocated to a user using a first scrambling code, and scrambling a second downlink physical channel allocated to the user using a second scrambling code, different from the first scrambling code. In another embodiment, the data throughput over downlink physical channels for a user is increased by increasing a number of scrambling codes used to scramble the downlink physical channels. And, in a further embodiment, a scheduler schedules transmission of at least one downlink physical channel on one of at least first and second antennas, where the downlink physical channel is allocated to a user. The scheduling is based on signal quality information for transmissions received by the user from the first and second antennas. The scheduler also selectively associates at least one scrambling code with the scheduled antenna, and a scrambler scrambles the downlink physical channel using the scrambling code associated with the scheduled antenna.

### BACKGROUND OF THE INVENTION

In wireless communication systems, an air interface is used for the exchange of information between a mobile station and a base station or other communication system equipment. The air interface typically comprises a plurality of communication channels. In wireless transmission, a channel is time varying due to fading, mobility, and so on. More specifically, channel quality is affected by factors such as distance between the mobile and base station, speed of the mobile station, interference, and the like. Given the limited resources (e.g., bandwidth) of wireless transmission as well as the large number of mobile stations supported by a base station at any given time, and therefore competing for those limited resources, it is important to maximize throughput of a wireless communication system. For example, in a time-multiplexed system in which the transmission time interval spans one or more time slots, system throughput can be maximized by allowing a user with the best channel quality to transmit ahead of users with comparatively low channel quality.

In one known arrangement, a mobile station performs a rate calculation based on measurements of a pilot signal from the base station once every time slot and then reports back the rate at which it is going to receive data from the base station. Alternatively, the mobile station can send channel quality feedback information to the base station and the base station can then select the appropriate rate corresponding to that channel quality. In general, the purpose of sending channel quality feedback information from the mobile station to the base station is to inform the base station of the transmission rate that best matches the current conditions (e.g., quality) of the channel at that present time.

In the evolving wireless data systems, such as the well known 1x-EV-DO and 1xEV-DV standards as well as the High Speed Downlink Packet Access (HSDPA) specification in the Universal Mobile Telecommunication System (UMTS) standard, the scheduling function is moved from base station controller to base station in order to provide “fast” scheduling based on channel quality feedback from the users. Moreover, new technologies such as adaptive modulation and coding (AMC) and hybrid ARQ (HARQ) have also been introduced to improve the overall system capacity. In general, a scheduler selects a user for transmission at a given time and adaptive modulation and coding allows selection of the appropriate transport format m(modulation and coding) for the current channel conditions seen by the user. A higher data transmission rate (i.e., throughput) is achieved by using high coding rates and/or higher order modulations and vice versa as shown in FIG. 9. FIG. 9 shows the coding rate (in parentheses) and the modulation (cooperatively referred to as transport format) used in relation to the signal-to-noise ratio (SNR). As shown, in order to increase the throughput by moving to a higher transport format, the SNR must be increased by transmitting at a higher power—and therefore increasing the level interference level with other signals.

FIG. 10 illustrates the spreading operation for downlink physical channels in UMTS. The non-spread physical channel consists of a sequence of real-valued symbols. Each pair of two consecutive symbols is first serial-to-parallel converted and mapped to an I and Q branches. The mapping is such that even and odd numbered symbols are mapped to the I and Q branches respectively. The I and Q branches are then spread to the chip rate by the same real-valued channelization code CHm. The sequences of real-valued chips on the I and Q branches are then treated as a single complex-valued sequence of chips. This sequence of chips is scrambled (complex chip-wise multiplication) by a complex-valued scrambling code SC.

A downlink physical channel corresponds to a channelization code. In HSDPA, channelization codes are of fixed spreading factor (SF) of 16 (i.e., there are 16 channelization codes used). However, multiple channelization codes can be allocated to a user within a transmission time interval (TTI). Moreover, multiple users can be code-multiplexed within a TTI. For example, if a total of 10 channelization codes are allocated, three users can share these codes with user A allocated 4 codes, user B allocated 3 codes and user C allocated 3 codes.

In HSDPA, a single scrambling code is used for all the physical channels (channelization codes) allocated to the same user or to different users. For a fixed number of channelization codes, different rates are achieved by varying coding rate and the modulation order. In the low rate voice communication of UMTS, more than one scrambling code is used, but not for the same user. The use of multiple scrambling codes is merely to increase the number of users that can be handled.

The symbols of all the streams in HSDPA are summed together to form a single in-phase stream and a single quadrature stream at chip rates of 3.84 Mc/s.

The relation between data rate, modulation coding parameters and the chip rate can be written as:

$${R}_{data} = {mR}_{coding} {R}_{chip} ( \frac{{N}^{i}}{i} ) [ Kb / s ] \qquad ( 1 )$$

where,

m=modulation order, 2,3, or 4 for QPSK, 8-PSK, and 16-QAM respectively;

R_{coding}: the effective coding rate;

R_{chip}: chip rate (e.g., 3.84Mc/s in UMTS); and

Nⁱ: number of i-ary channelization codes allocated to the user.

For example, at an effective coding rate of ½, 16-QAM modulation and 8 16-ary channelization codes allocated to the user, the data rate is 3.84 Mb/s.

Note that as the number of available channelization codes is small, the system has to use either higher order modulations (large m or higher coding rates (weaker codes) in order to achieve a given data rate. In general, the higher order modulations and weaker codes require larger signal-to-noise ratios (SNRs) to achieve a given bit error rate (BER) and/or frame error rate (FER) target. Therefore, for a given FER target, the supportable data rate is not only a function of the SNR but also the available channelization codes (which in turn determines the modulation and coding parameters for a given data rate).

With one scrambling code the channelization codes are shared between the HSDPA service and other UMTS services. The example in FIG. 11 shows that half the channelization code space is used by HSDPA service and the other half by other UMTS channels.

As discussed above, the rate adaptation in existing wireless systems suffers from several disadvantages, namely inefficient resource usage and degraded performance due to use of suboptimal demodulation method for higher order modulations. In particular, as discussed above a higher transmit power is needed to compensate for the loss in coding performance and meet the SNR requirements for higher order modulations.

### SUMMARY OF THE INVENTION

The inventors have recognized that throughput to a single user (e.g., a mobile station of the user) can be increased by using more than one scrambling code in scrambling downlink physical channels destined for the user. By using additional scrambling codes, the channelization codes can be reused. Namely, a downlink physical channel is defined by the unique combination of a channelization code and a scrambling code. Hence, using an additional scrambling code doubles the number of downlink physical channels. By allocating more of the downlink physical channels to the user, throughput increases.

The inventors have also recognized that throughput can be increased by using multiple scrambling codes and reducing the effective coding rate and/or the order of the modulation scheme as compared to when a single scrambling code is used. And, while using multiple scrambling codes introduces additional interference, the amount of interference is less than that introduced when increasing throughput by using higher orders of modulation as in the prior art single scrambling code transport format schemes.

Furthermore, using multiple scrambling codes permits allocating scrambling codes to particular antennas in a multiple transmit antenna system, and then scheduling transmission to a user using an antenna having a preferred link quality with the user.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates an apparatus for performing a spreading operation according to an embodiment of the present invention;

FIG. 2A illustrates the channelizer and scrambler of FIG. 1 in greater detail;

FIG. 2B illustrates a code-tree for generating orthogonal variable spreading factor codes;

FIG. 3 illustrates the channelization codes available in an embodiment of the present invention;

FIG. 4 illustrates the channelization codes that can be allocated to a single user according to an embodiment of the present invention;

FIG. 5 illustrates the channelization codes allocated to multiple users according to an embodiment of the present invention;

FIG. 6 illustrates a transport format scheme according to an embodiment of the present invention;

FIG. 7 illustrates an example of scheduling two users at two antennas using different scrambling codes according to an embodiment of the present invention;

FIG. 8 illustrates a system architecture for implementing the scheduling example of FIG. 7;

FIG. 9 illustrates a transport format scheme according to the prior art;

FIG. 10 illustrates a channelization and scrambling architecture according to the prior art; and

FIG. 11 illustrates the channelization codes available in the prior art.

### DETAILED DESCRIPTION OF EMBODIMENTS

System Architecture

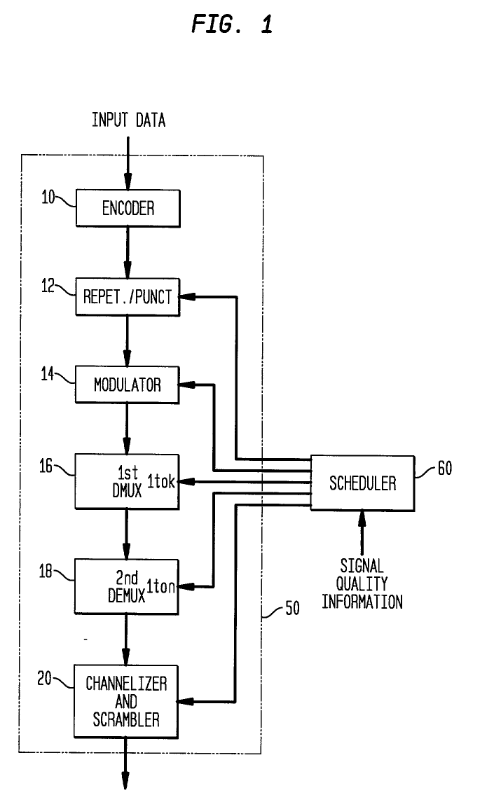

FIG. 1 illustrates the apparatus for performing the spreading operation according to an embodiment of the present invention. As shown, input data destined for a user (e.g., a mobile station of the user) is input to a processing system 50. The processing system 50 includes an encoder 10, which error correcting encodes the input data at a particular fixed coding rate (e.g., ⅓). A repetition/puncturing unit 12 then punctures or repeats the data under the control of a scheduler 60 to obtain a desired coding rate (e.g., 0.80) also referred to as the effective coding rate. Next, a modulator 14 modulates the input data according to a modulation scheme (e.g., QPSK, 8PSK, 16 QAM, etc.) as instructed by the scheduler 60, converts the serial data into parallel data and maps the parallel data to I and Q branches. The mapping is such that even and odd numbered symbols are mapped to the I and Q branches, respectively.

The I and Q branches are fed to a first demultiplexer 16, which divides the I and Q branches into i pairs of I and Q branches, where i=1 to k and k is the maximum number of scrambling codes. The number i is controlled by the scheduler 60 and, as discussed in detail below, equals the number of scrambling codes used in transmitting the input data. A second demultiplexer 18 receives the i pairs of I and Q signals and demultiplexes each ith pair of I and Q signals into 1 to n pairs of I and Q signals, where n is the maximum number of available channelization codes. The number of I and Q pairs that each ith pair of I and Q signals is divided into is controlled by the scheduler 60, and, as discussed in detail below is equal to the number of channelization codes used in transmitting the input data to the user using an associated scrambling code.

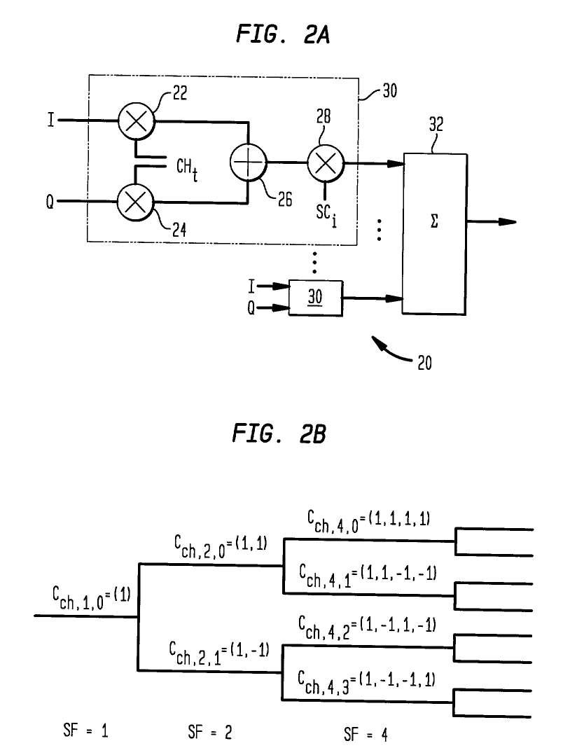

A channelizer and scrambler 20 then spreads and scrambles the I and Q signals for transmission under the control of the scheduler 60. FIG. 2A illustrates the channelizer and scrambler 20 in greater detail. As shown, each pair of I and Q signals from the second demultiplexer 18 is received by a respective channelizing and scrambling unit 30. The received I and Q signals are respectively mixed by mixers 22 and 24 (also called multipliers) with a channelization code CHt supplied by the scheduler 60, where t=1 to n.

The channelization codes preserve the orthogonality between different physical channels. The channelization codes can be defined using the code tree of FIG. 2B. In FIG. 2B, the channelization codes are uniquely described as C_{ch,SF,k}, where SF is the spreading factor of the code and k is the code number, 0≦k≦SF−1. Each level in the code tree defines channelization codes of length SF, corresponding to a spreading factor of SF in FIG. 2B. The channelization codes in HSDPA use a fixed spreading factor (SF) of 16.

The generation method for the channelization code is defined as:

$$\begin{matrix}{C}_{ch , 1 , 0} = 1 , \\ [ \begin{matrix}{C}_{ch , 2 , 0} \\ {C}_{ch , 2 , 1}\end{matrix} ] = [ \begin{matrix}{C}_{ch , 1 , 0} & {C}_{ch , 1 , 0} \\ {C}_{ch , 1 , 0} & - {C}_{ch , 1 , 0}\end{matrix} ] = [ \begin{matrix}1 & 1 \\ 1 & - 1\end{matrix} ] \\ [ \begin{matrix}{C}_{ch , {2}^{( n + 1 )} , 0} \\ {C}_{ch , {2}^{( n + 1 )} , 1} \\ {C}_{ch , {2}^{( n + 1 ) , 2 }} \\ {C}_{ch , {2}^{( n + 1 )} , 3} \\ ⋮ \\ {C}_{ch , {2}^{( n + 1 )} , {2}^{( n + 1 )} - 2} \\ {C}_{ch , {2}^{( n + 1 )} , {2}^{( n + 1 )} - 1}\end{matrix} ] = [ \begin{matrix}{C}_{ch , {2}^{n} , 0} & {C}_{ch , {2}^{n} , 0} \\ {C}_{ch , {2}^{n} , 0} & - {C}_{ch , {2}^{n} , 0} \\ {C}_{ch , {2}^{n} , 1} & {C}_{ch , {2}^{n} , 1} \\ {C}_{ch , {2}^{n} , 1} & - {C}_{ch , {2}^{n} , 1} \\ ⋮ & ⋮ \\ {C}_{ch , {2}^{n} , {2}^{n} - 1} & {C}_{ch , {2}^{n} , {2}^{n} - 1} \\ {C}_{ch , {2}^{n} , {2}^{n} - 1} & - {C}_{ch , {2}^{n} , {2}^{n} - 1}\end{matrix} ]\end{matrix}$$

An adder 26 adds the results to produce a composite signal, and a mixer 28 mixes the composite signal with a scrambling code supplied by the scheduler 60. The scrambling code sequences are constructed by combining two real sequences into a complex sequence. Each of the two real sequences are constructed as the position wise modulo 2 sum of 38400 chip segments of two binary m-sequences generated by means of two generator polynomials of degree 18. The resulting sequences thus constitute segments of a set of Gold sequences. Let x and y be the two sequences respectively. The x sequence is constructed using the primitive (over GF(2)) polynomial 1+X⁷+X¹⁸. The y sequence is constructed using the polynomial 1+X⁵+X⁷+X¹⁰+X¹⁸. The sequence depending on the chosen scrambling code number n is denoted zₙ, in the sequel. Furthermore, let x(i), y(i) and zₙ(i) denote the i:th symbol of the sequence x, y, and zₙ, respectively. The m-sequences x and y are constructed as:

Initial conditions:

x is constructed with x(0)=1, x(1)=x(2)= . . . =x(16)=x(17)=0.

y(0)=y(1)= . . . =y(16)=y(17)=1.

Recursive definition of subsequent symbols:

x(i+18)=x(i+7)+x(i) modulo 2, i=0, . . . , 2¹⁸−20.

y(i+18)=y(i+10)+y(i+7)+y(i+5)+y(i) modulo 2, i=0, . . . , 2¹⁸−20.

The n:th Gold code sequence zₙ, n=0, 1, 2, . . . , 2¹⁸−2, is then defined as:

zₙ(i)=x((i+n) modulo(2¹⁸−1))+y(i) modulo 2, i=0, . . . , 2¹⁸−2.

These binary sequences are converted to real valued sequences Zₙ by the following transformation:

$${Z}_{n} ( i ) = \{ \begin{matrix}+ 1 & if {z}_{n} ( i ) = 0 \\ - 1 & if {z}_{n} ( i ) = 1 \end{matrix} for i = 0 , 1 , … , {2}^{18} - 2.$$

Finally, the n:th complex scrambling code sequence S_{d1, n} is defined as:

S_{d1,n}(i)=Zₙ(i)+jZₙ((i+131072) modulo (2¹⁸−1)), i=0, 1, . . . , 38399.

This method of generating a scrambling code is an example of the scrambling code generation technique used in UMTS. It will be appreciated that any other pseudorandom sequences can also be used as the scrambling codes.

The scrambled composite signals from each of the channelizing and scrambling units 30 are summed by a summer 32 to produce a signal for transmission. In the present invention, each unique pair of a channelization code and scrambling code defines a downlink physical channel.

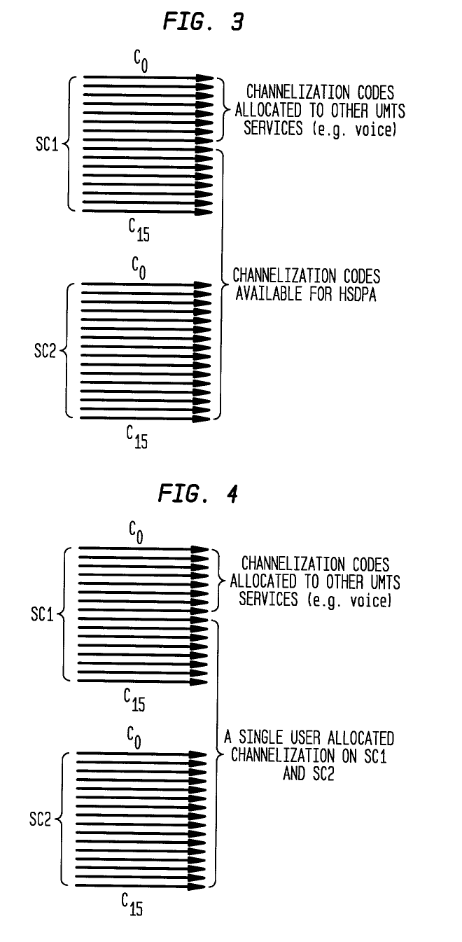

With the use of more than one scrambling code, the number of available channelization codes increase. More specifically, the same channelization code can be used with two or more scrambling codes. For example, in FIG. 3 the same SF16 codes are used on SC1 and SC2. Note that now HSDPA can also use channelization codes on SC2 that are sued by other UMTS channels on SC1.

The relation between data rate, modulation-coding parameters, number of scrambling codes and the chip rate can now be written as:

$${R}_{data} = {mR}_{coding} {R}_{chip} ( {N}_{SC} + \frac{{N}^{i}}{i} ) [ Kb / s ] \qquad ( 2 )$$

where, N_{sc} is the number of secondary scrambling codes. Note that the total number of scrambling codes is (N_{sc}+1) because there is always a primary scrambling code.

For example, at an effective coding rate of ½, 16-QAM modulation and eight16-ary channelization codes allocated on SC1 and sixteen 16-ary channelization codes allocated on SC2, the data rate turns out to be 11.52 Mb/s using equation (2). Therefore, use of more than one scrambling code allows achieving higher data rates without increasing the coding rate or modulation order. Note that with only eight16-ary channelization codes allocated on SC1, the data rate achieved with coding rate of ½ and 16-QAM modulation is only 3.84 Mb/s.

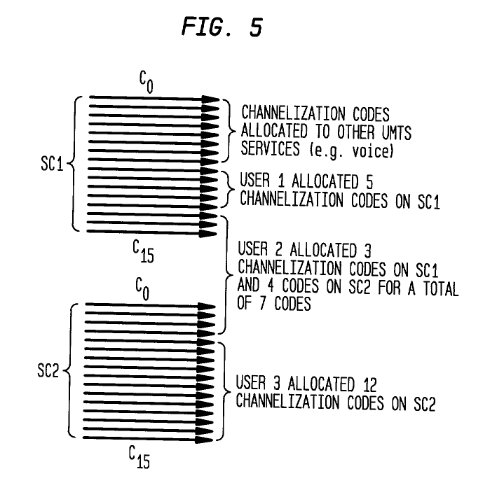

The higher rates are achieved by allocating channelization codes on more than one scrambling code to the same user as shown in FIG. 4. The channelization codes on SC1 and SC2 can also be shared among multiple users as shown in FIG. 5

Multiple scrambling codes reduce the need for very high order modulations. For example, assuming similar coding rates, 16-QAM modulation with two scrambling codes will achieve a data rate identical to 256-QAM modulation with one scrambling code.

An example of data rates in the HSDPA system is shown in Table 1. For example with 10 channelization codes and a code block (information block) size of 15360 bits, 16-QAM modulation and 0.8 coding rate, a data rate of 7.68 Mb/s is achieved. However, with 2 scrambling codes, the same data rate can be achieved by either using QPSK with a 0.8 coding rate or 16-QAM with a 0.4 coding rate. Moreover, with 16-QAM, a 0.8 coding rate and 2 scrambling codes a data rate of 15.36 Mb/s can be achieved that can only be achieved by 256-QAM modulation and a 0.8 coding rate with a single scrambling code. Therefore, scrambling code allows achieving higher data rates with the use of lower coding rates and/or lower order modulations compared to a single scrambling code.

TABLE 1
An example of data rates in the HSDPA system. The cells marked “X” correspond to non seif-decodable
transmissions and may be used only for retransmission.

| | Modulation and Coding Schemes | | | | | | |
|---|---|---|---|---|---|---|---|
| Number of | 1280 bits | 2560 bits | 3840 bits | 5120 bits | 7680 bits | 11520 bits | 15360 bits |
| channelization | code block | code block | code block | code block | code block | code block | code block |
| codes of SF 16 | 640 Kbps | 1280 Kbps | 1920 Kbps | 2560 Kbps | 3840 Kbps | 5760 Kbps | 7680 Kbps |
| 10 | QPSK, 0.13 | QPSK, 0.27 | QPSK, 0.4 | QPSK, 0.53 | QPSK, 0.8 | 16QAM, 0.6 | 16QAM, 0.8 |
| 8 | QPSK, 0.17 | QPSK, 0.33 | QPSK, 0.5 | QPSK, 0.67 | 16QAM, 0.5 | 16QAM, 0.75 | |
| 6 | QPSK, 0.22 | QPSK, 0.44 | QPSK, 0.67 | 16QAM, 0.44 | 16QAM, 0.67 | X | X |
| 4 | QPSK, 0.33 | QPSK, 0.67 | 16QAM, 0.5 | 16QAM, 0.67 | X | X | X |
| 2 | QPSK, 0.67 | 16QAM, 0.67 | X | X | X | X | X |

Rate Adaptation

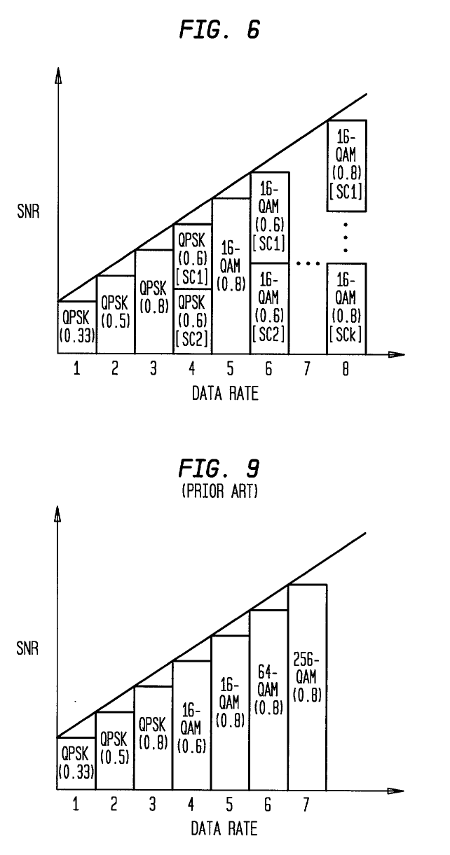

An example of rate adaptation with 2 scrambling codes used by the scheduler 60 is shown in FIG. 6. Namely, in the same manner that the prior art scheduler chose a transport format using FIG. 9, the scheduler 60 chooses a transport format using FIG. 6. Note that the second scrambling code is only used at high SNR. This is due to the fact that high coding rates and higher order modulations are used when the SNR is high. At low SNR, low coding rates and lower order modulation are used to provide the necessary robustness. For example if a single scrambling code is used with QPSK and 0.5 coding rate (transport format 2), the two scrambling codes will provide a coding rate of 0.25 with QPSK. The coding gain from 0.5 rate to 0.25 rate may not justify the increase in interference (loss in orthogonality) due to a second scrambling code.

However, at high SNR, the gain due to lower coding rates and lower order modulation enabled by multiple scrambling codes can be greater than the loss due to additional interference. For example, transport format 4 in FIG. 9 and transport format 4 in FIG. 6 achieve the same data rate with the former using 16-QAM and the latter using QPSK. However, the amount of interference introduced by using a higher SNR and the two scrambling codes with transport format 4 of FIG. 6 can be less than the amount of interference introduced by using transport format 4 of FIG. 9 at its required higher SNR. Moreover, very high data rates like transport format 8 in FIG. 6 can be achieved with multiple scrambling codes and modulation schemes with substantially lower constellation sizes than their counter parts in FIG. 9.

While one example a transport format scheme using multiple scrambling codes has been provided in FIG. 6, it will be appreciated that the present invention is not limited to this example. Instead, depending on design considerations, a system designer will develop alternative transport format schemes. For example, instead of or in addition to reducing the coding rate when increasing throughput using more than one scrambling code in a transport format (compare transport formats 3 and 4 of FIG. 6), the order of the modulation scheme can be reduced. Additionally or alternatively, the number of scrambling codes used in a given transport format is not limited to two.

In HSDPA, a Shared Control Channel (HS-SCCH) carries HS-DSCH (high speed—downlink shared channel) related downlink signaling for one user equipment UE (e.g., a mobile station of a user). The Shared-Control-Channel information consists of channelization code set, modulation scheme, Transport-block-set size, Transport-channel identity and Hybrid-ARQ-related information etc. When multiple scrambling codes are used, the information about the scrambling code can also be carried on the HS-SCCH. Note that the shared control channels can themselves be on a single scrambling code but the actual data transmission on the HS-DSCH can use different scrambling codes.

Rate Adaptation Using Multiple Scrambling Codes (Contd. 1)—Use with Multiple Antennas

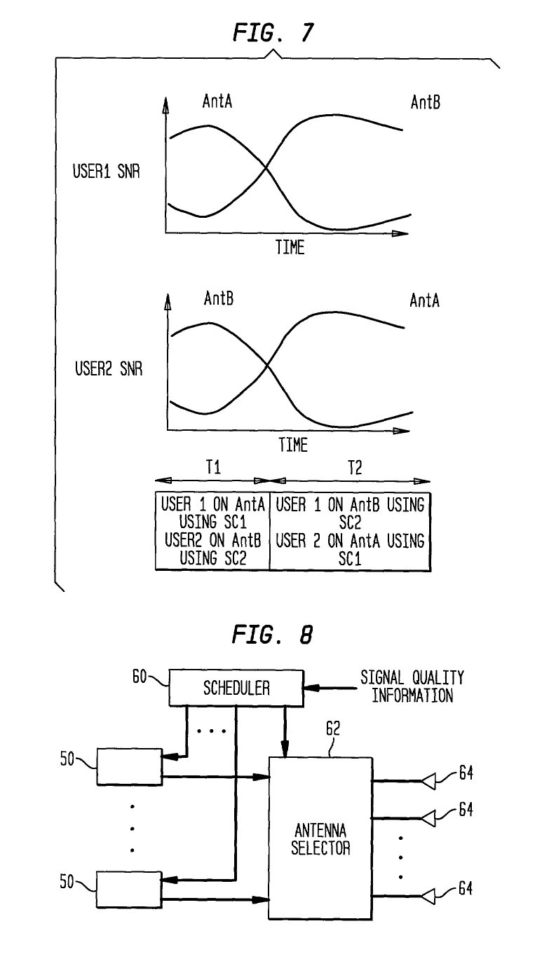

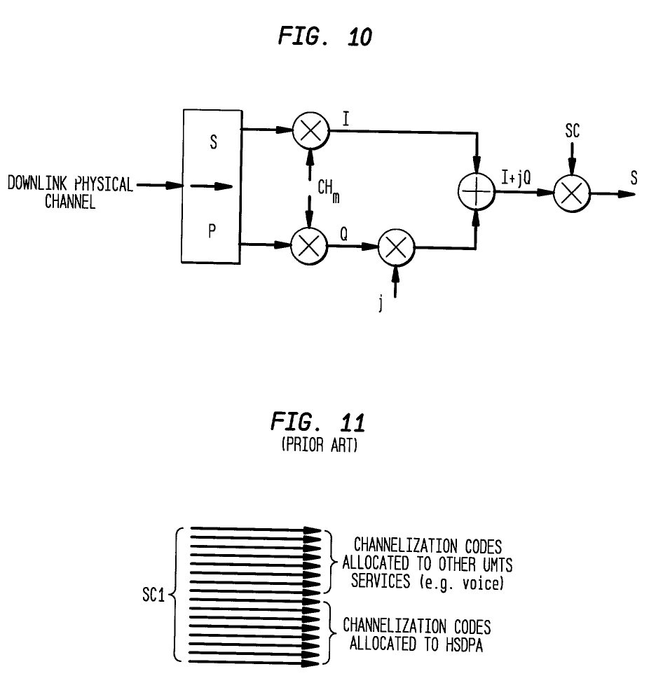

An example of scheduling users on two antennas using two different scrambling codes is shown conceptually in FIG. 7. The SNR seen by a user (e.g., the mobile station of a user) from the two antennas are, in general, uncorrelated if the antennas are placed sufficiently apart. In the FIG. 7, user1 sees better SNR on antenna A during time period T1 and on antenna B during time period T2. The user2 sees better SNR on antenna A during time period T2 and on antenna B during time period T1 . In order to maximize system throughput, the scheduler 60 at the base station receives the signal quality information from the user 1 and the user 2, and schedules user1 on antenna A and user2 on antenna2 during time T1 . Similarly, during time T2, user1 can be scheduled on antenna B and user2 on antenna A.

The two users will have to share the channelization codes if only one scrambling code is used for transmission. However, if multiple scrambling codes are available, both users can use all the available channelization codes. For example, transmissions on antenna A can use SC1 while transmissions on antenna B can use SC2. In general, when more than one scrambling code is used, the transmissions on the same channelization code but two different scrambling codes are no longer orthogonal. Therefore, during time T1, user1 using SC1 will see interference from transmission of user2 on SC2. However, when multiple scrambling codes are used in conjunction with multiple antennas, the cross-interference can be reduced. For example, during time T1 when user1 is using SC1 on antenna A, the received power seen by user 1 from antenna B is low due to a destructive fade from antenna B. The signal strength seen by user1 from antenna A is higher due to constructive fading. As mentioned previously, when the antennas are placed a sufficient distance from one another, the fading is independent. Therefore, the interference seen by user1 during time T1 from SC2 will be lower as well. Similarly, interference seen by user2 from SC1 will be small. The low interference from the other scrambling code will increase the overall signal quality for the two users resulting in improved system capacity.

FIG. 8 illustrates the system architecture for performing the rate adaptation using multiple scrambling codes with multiple antennas as described above. As shown, a processing system 50 is associated with each user, and the scheduler 60 controls, among other things, the scrambling codes applied by each of the processing system 50. The scheduler 60 also controls an antenna selector 62, which selectively sends the output from the processing systems 50 to antennas 64. Accordingly, the scheduler 60 controls the scrambling codes applied by the processing systems 50 and the antenna selector 62 as described in detail above based on the signal quality information to increase the overall signal quality for the users.

The invention being thus described, it will be obvious that the same may be varied in many ways. Such variations are not to be regarded as a departure from the spirit and scope of the invention, and all such modifications are intended to be included within the scope of the following claims.

1. A method of processing downlink physical channels, comprising:
scrambling a first downlink physical channel allocated to a user using a first scrambling code; and
scrambling a second downlink physical channel allocated to the user using a second scrambling code, different from the first scrambling code.

2. The method of claim 1, wherein the first and second downlink physical channels are complex valued, and the first and second scrambling codes are complex valued.

3. The method of claim 1, wherein the first and second downlink physical channels are complex valued sequences of chips.

4. The method of claim 3, wherein and the first and second scrambling codes are complex valued.

5. The method of claim 1, further comprising:
spreading the first downlink physical channel using a first channelization code;
spreading the second downlink physical channel using a second channelization code, which is one of different and same as the first channelization code; and wherein
the scrambling the first downlink physical channel step scrambles the spread first downlink physical channel; and
the scrambling the second downlink physical channel step scrambles the spread second downlink physical channel.

6. The method of claim 1, further comprising:
splitting the first downlink physical channel into first I and first Q branches;
spreading the first I and first Q branches using a first channelization code;
adding the first spread I and first spread Q branches to form a first composite channel;
splitting the second downlink physical channel into second I and second Q branches;
spreading the second I and second Q branches using a second channelization code, which is one of different and same as the first channelization code;
adding the second spread I and second spread Q branches to form a second composite channel; and wherein
the scrambling the first downlink physical channel step scrambles the first composite channel; and
the scrambling the second downlink physical channel step scrambles the second composite channel.

7. The method of claim 6, further comprising:
summing the first and second scrambled composite channels.

8. A method of processing channels, comprising:
serial-to-parallel converting a first sequence of symbols into a first I branch and a first Q branch;
mixing the first I and first Q branches with a first channelization code;
adding the first mixed I and first mixed Q branches to form a first single complex valued sequence of chips;
mixing the first single complex valued sequence of chips with a first complex valued scrambling code;
serial-to-parallel converting a second sequence of symbols into a second I branch and a second Q branch;
mixing the second I and second Q branches with a second channelization code;
adding the second mixed I and second mixed Q branches to form a second single complex valued sequence of chips;
mixing the second single complex valued sequence of chips with a second complex valued scrambling code, different from the first complex valued scrambling code.

9. The method of claim 8, further comprising:
summing the first and second scrambled single complex valued sequence of chips.

10. An apparatus for processing downlink physical channels, comprising:
a first mixer scrambling a first downlink physical channel allocated to a user using a first scrambling code; and
a second mixer scrambling a second downlink physical channel allocated to the user using a second scrambling code, different from the first scrambling code.

11. The apparatus of claim 10, wherein the first and second downlink physical channels are complex valued, and the first and second scrambling codes are complex valued.

12. The apparatus of claim 10, wherein the first and second downlink physical channels are complex valued sequences of chips.

13. The apparatus of claim 12, wherein and the first and second scrambling codes are complex valued.

14. The apparatus of claim 10, further comprising:
a first serial-to-parallel converter serial-to-parallel converting a first sequence of symbols into a first I branch and a first Q branch;
third and fourth mixer respectively mixing the first I and first Q branches with a first channelization code;
a first adder adding the first mixed I and first mixed Q branches to form a first single complex valued sequence of chips;
a second serial-to-parallel converter serial-to-parallel converting a second sequence of symbols into a second I branch and a second Q branch;
fifth and sixth mixers respectively mixing the second I and second Q branches with a second channelization code;
a second adder adding the second mixed I and second mixed Q branches to form a second single complex valued sequence of chips; and wherein
the first mixer mixes the first single complex valued sequence of chips with the first scrambling code, the first scrambling code being complex valued; and
the second mixer mixes the second single complex valued sequence of chips with the second scrambling code, the second scrambling code being complex valued.

15. The apparatus of claim 14, further comprising:
a summer summing the first and second scrambled single complex valued sequence of chips.

16. The apparatus of claim 10, further comprising:
a summer summing the first and second scrambled downlink physical channels.

17. A method of processing downlink physical channels, comprising:
increasing data throughput over downlink physical channels for a user by increasing a number of scrambling codes used to scramble the downlink physical channels.

18. The method of claim 17, wherein the increasing step increases the throughput while decreasing a modulation order of a modulation scheme used to modulate the downlink physical channels.

19. The method of claim 18, wherein the increasing step increases the throughput while decreasing an effective coding rate of the downlink physical channels.

20. The method of claim 17, wherein the increasing step increases the throughput while decreasing an effective coding rate of the downlink physical channels.

21. An apparatus for processing downlink physical channels, comprising:
a scheduler increasing data throughput over downlink physical channels for a user by increasing a number of scrambling codes used to scramble the downlink physical channels.

22. The apparatus of claim 21, wherein the scheduler increases the throughput while decreasing a modulation order of a modulation scheme used to modulate the downlink physical channels.

23. The method of claim 22, wherein the scheduler increases the throughput while decreasing an effective coding rate of the downlink physical channels.

24. The method of claim 21, wherein the scheduler increases the throughput while decreasing an effective coding rate of the downlink physical channels.

25. A method of processing downlink physical channels, comprising:
scheduling transmission of at least one downlink physical channel on one of at least first and second antennas, the downlink physical channel allocated to a user, and the scheduling being based on signal quality information for transmissions received by the user from the first and second antennas;
selectively associating at least one scrambling code with the scheduled antenna; and
scrambling the downlink physical channel using the scrambling code associated with the scheduled antenna.

26. The method of claim 25, wherein the signal quality information is signal-to-noise ratio.

27. The method of claim 25, wherein the scheduling step schedules the downlink physical channel on one of at least the first and second antennas that the signal quality information indicates the user receives with higher quality.

28. The method of claim 27, wherein the scheduling step schedules the downlink physical channel on one of a plurality of antennas.

29. An apparatus for processing downlink physical channels, comprising:
a scheduler scheduling transmission of at least one downlink physical channel on one of at least first and second antennas, the downlink physical channel allocated to a user, and the scheduling being based on signal quality information for transmissions received by the user from the first and second antennas, the scheduler selectively associating at least one scrambling code with the scheduled antenna; and
a scrambler scrambling the downlink physical channel using the scrambling code associated with the scheduled antenna.

30. The apparatus of claim 29, wherein the signal quality information is signal-to-noise ratio.

31. The apparatus of claim 29, wherein the scheduler schedules the downlink physical channel on one of at least the first and second antennas that the signal quality information indicates the user receives with higher quality.

32. The apparatus of claim 31, wherein the scheduler schedules the downlink physical channel on one of a plurality of antennas.
